(19) United States
(12) Patent Application Publication
(10) Pub. No.: US 2018/0180180 A1
(43) Pub. Date: Jun. 28, 2018

(54) CONTROL SYSTEM FOR VEHICULAR POWER TRANSMISSION SYSTEM AND CONTROL METHOD FOR VEHICULAR POWER TRANSMISSION SYSTEM

(71) Applicant: TOYOTA JIDOSHA KABUSHIKI KAISHA, Toyota-shi (JP)

(72) Inventors: Susumu MORITOMO, Toyota-shi (JP); Mitsuhiro FUKAO, Toyota-shi (JP); Makoto SAWADA, Nisshin-shi (JP); Satoshi KATOH, Toyota-shi (JP)

(73) Assignee: TOYOTA JIDOSHA KABUSHIKI KAISHA, Toyota-shi (JP)

(21) Appl. No.: 15/851,822

(22) Filed: Dec. 22, 2017

(30) Foreign Application Priority Data
Dec. 28, 2016 (JP) 2016-255990

(51) Int. Cl. F16H 61/70; F16H 37/08

(52) U.S. Cl. CPC F16H 61/702; F16H 2059/366; F16H 37/0846

(57) ABSTRACT

When the speed ratio of a belt-type continuously variable transmission is equal to or larger than a predetermined threshold value, switching between a first power transmission path including a gear transmission mechanism and a second power transmission path including a belt-type continuously variable transmission is performed by means of clutches, so as to reduce a difference in an input shaft rotational speed applied to the clutches before and after the switching.

### INCORPORATION BY REFERENCE

The disclosure of Japanese Patent Application No. 2016-255990 filed on Dec. 28, 2016 including the specification, drawings and abstract is incorporated herein by reference in its entirety.

### BACKGROUND

### 1. Technical Field

The disclosure relates to a control system and a control method for a vehicular power transmission system, and is concerned with control of the control system for the vehicular power transmission system including a clutch mechanism that switches between a belt-type continuously variable transmission and a transmission mechanism having a gear or gears.

2. Description of Related Art

A vehicular power transmission system according to the related art includes a belt-type continuously variable transmission, a transmission mechanism having at least one gear ratio, and a clutch mechanism. The belt-type continuously variable transmission includes a primary pulley and a secondary pulley provided between an input shaft to which torque delivered from a drive power source is transmitted, and an output shaft that delivers torque to drive wheels, and a transmission belt that is looped around the primary pulley and the secondary pulley. The clutch mechanism switches a torque transmission path between a first transmission path through which torque delivered from the drive power source can be transmitted to the output shaft via the transmission mechanism, and a second transmission path through which the torque can be transmitted to the output shaft via the belt-type continuously variable transmission. In Japanese Patent Application Publication No. 2016-3673 (JP 2016-3673 A), for example, shift control for performing clutch-to-clutch shifting to release one clutch and engage the other clutch, so as to switch the torque transmission path between the first transmission path and the second transmission path, is disclosed.

### SUMMARY

In the vehicular power transmission system including the structure of JP 2016-3673 A, if a clutch-to-clutch shift for switching the torque transmission path between the first transmission path and the second transmission path is performed, in a condition where the speed ratio of the belt-type continuously variable transmission is on the high-gear side, namely, where the speed ratio is small, and a difference in rotation between the input shaft and the output shaft is large, the amount of heat generated by a friction material of clutches used in the clutch mechanism is increased, and the durability of the clutch mechanism may be reduced.

This disclosure provides a control system and a control method for a vehicular power transmission system, which curbs reduction of the durability by reducing the amount of heat generated in the clutch mechanism, when a clutch-to-clutch shift for switching the torque transmission path between the first transmission path and the second transmission path is performed.

A first aspect of the disclosure provides a control system for a vehicular power transmission system. The vehicular power transmission system includes a belt-type continuously variable transmission, a transmission mechanism having at least one gear ratio, and a clutch mechanism. The belt-type continuously variable transmission includes a primary pulley provided on an input shaft to which torque delivered from a drive power source is transmitted, a secondary pulley provided on an output shaft that delivers the torque to drive wheels, and a transmission belt looped around the primary pulley and the secondary pulley. The clutch mechanism is configured to switch a torque transmission path between a first transmission path through which the torque delivered from the drive power source can be transmitted to the output shaft via the transmission mechanism, and a second transmission path through which the torque can be transmitted to the output shaft via the belt-type continuously variable transmission. The control system includes an electronic control unit configured to switch the torque transmission path between the first transmission path and the second transmission path, when a speed ratio of the belt-type continuously variable transmission is equal to or larger than a predetermined threshold value.

With the control system configured as described above, when the belt-type continuously variable transmission and the transmission mechanism are switched for use in torque transmission, shift control is started after the speed ratio of the belt-type continuously variable transmission is changed to the low-gear side. Therefore, the amount of heat generated by a friction material used in the clutch mechanism is reduced, as compared with that in the case where shift control is started in a condition where the speed ratio is on the high-gear side, or the speed ratio is small and a difference in rotation between the input shaft and the output shaft is large. As a result, reduction of the durability of the friction material is effectively curbed.

In the control system as described above, the electronic control unit may be configured to change the threshold value based on a vehicle speed, according to a pre-stored relationship.

With the above configuration, reduction of the durability of the friction material used in the clutch mechanism is more effectively curbed, and the threshold value is more accurately set based on the vehicle speed. This makes it possible to select the smaller speed ratio, and switch the torque transmission path between the first transmission path and the second transmission path at an earlier opportunity.

In the control system as described above, the electronic control unit may be configured to change the threshold value based on an oil temperature within the vehicular power transmission system, according to a pre-stored relationship.

With the above configuration, reduction of the durability of the friction material used in the clutch mechanism is more effectively curbed, and the threshold value is more accurately set based on the oil temperature. This makes it possible to select the smaller speed ratio, and switch the torque transmission path between the first transmission path and the second transmission path at an earlier opportunity.

In the control system as described above, the drive power source may be an engine, and the electronic control unit may be configured to change the threshold value based a coolant temperature of the engine, according to a pre-stored relationship.

With the above configuration, reduction of the durability of the friction material used in the clutch mechanism is more effectively curbed, and the threshold value is more accurately set based on the coolant temperature of the engine. This makes it possible to select the smaller speed ratio, and switch the torque transmission path between the first transmission path and the second transmission path at an earlier opportunity.

In the control system as described above, the drive power source may be an engine, and the electronic control unit may he configured to inhibit switching of the torque transmission path, when a rotational speed of the engine after switching of the torque transmission path is expected to he equal to or higher than an over-revolution rotational speed that is set in advance for curbing excessive rotation.

With the above configuration, reduction of the durability of the friction material used in the clutch mechanism is more effectively curbed, and the engine speed after switching of the torque transmission path is effectively prevented from exceeding the over-revolution rotational speed set in advance for curbing excessive rotation.

A second aspect of the disclosure provides a control method for a vehicular power transmission system. The vehicular power transmission system includes a belt-type continuously variable transmission, a transmission mechanism having at least one gear ratio, a clutch mechanism, and an electronic control unit. The belt-type continuously variable transmission includes a primary pulley provided on an input shaft to which torque delivered from a drive power source is transmitted, a secondary pulley provided on an output shaft that delivers the torque to drive wheels, and a transmission belt looped around the primary pulley and the secondary pulley. The clutch mechanism is configured to switch a torque transmission path between a first transmission path through which the torque delivered from the drive power source can be transmitted to the output shaft via the transmission mechanism, and a second transmission path through which the torque can be transmitted to the output shaft via the belt-type continuously variable transmission. The control method includes the steps of determining, by the electronic control unit, whether a speed ratio of the belt-type continuously variable transmission is equal to or larger than a predetermined threshold value, and switching, by the electronic control unit, the torque transmission path between the first transmission path and the second transmission path, when the speed ratio of the belt-type continuously variable transmission is equal to or larger than the predetermined threshold value.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view illustrating the general configuration of a vehicle to which the disclosure is applied;

FIG. 2 is a view useful for explaining switching of traveling patterns of a power transmission system in the vehicle of FIG. 1;

FIG. 3 is a view useful for explaining control functions and a principal part of a control system for various controls performed in the vehicle of FIG. 1;

FIG. 4 is a graph showing one example of threshold value of the speed ratio for curbing heat generation in a clutch mechanism, which occurs at the time of switching of the traveling patterns of FIG. 2;

FIG. 5 is a graph showing the relationship between heat generation in the clutch mechanism on a downshift as one example of switching of the traveling patterns of FIG. 2, and the turbine rotational speed;

FIG. 6 is a flowchart illustrating one example of a belt shift control routine as a part of control of the clutch mechanism based on the speed ratio of FIG. 4;

FIG. 7 is a flowchart illustrating one example of a clutch shift control routine as a part of control of the clutch mechanism based on the speed ratio of FIG. 4;

FIG. 8 is a flowchart illustrating another example of the clutch shift control routine of FIG. 7;

FIG. 9 is a time chart showing one example of control of the disclosure at the time of switching from a transmission mechanism to a belt-type continuously variable transmission;

FIG. 10 is a time chart showing one example of control of the disclosure at the time of switching from the belt-type continuously variable transmission to the transmission mechanism;

FIG. 11 is a graph showing one example in which the threshold value of the speed ratio for curbing heat generation in the clutch mechanism in FIG. 4 is changed based on the vehicle speed;

FIG. 12 is a graph showing one example in which the threshold value of the speed ratio for curbing heat generation in the clutch mechanism in FIG. 4 is changed based on the oil temperature of hydraulic oil; and

FIG. 13 is a graph showing one example in which the threshold value of the speed ratio for curbing heat generation in the clutch mechanism in FIG. 4 is changed based on the engine coolant temperature.

### DETAILED DESCRIPTION OF EMBODIMENTS

A first embodiment of the disclosure will be described in detail with reference to the drawings.

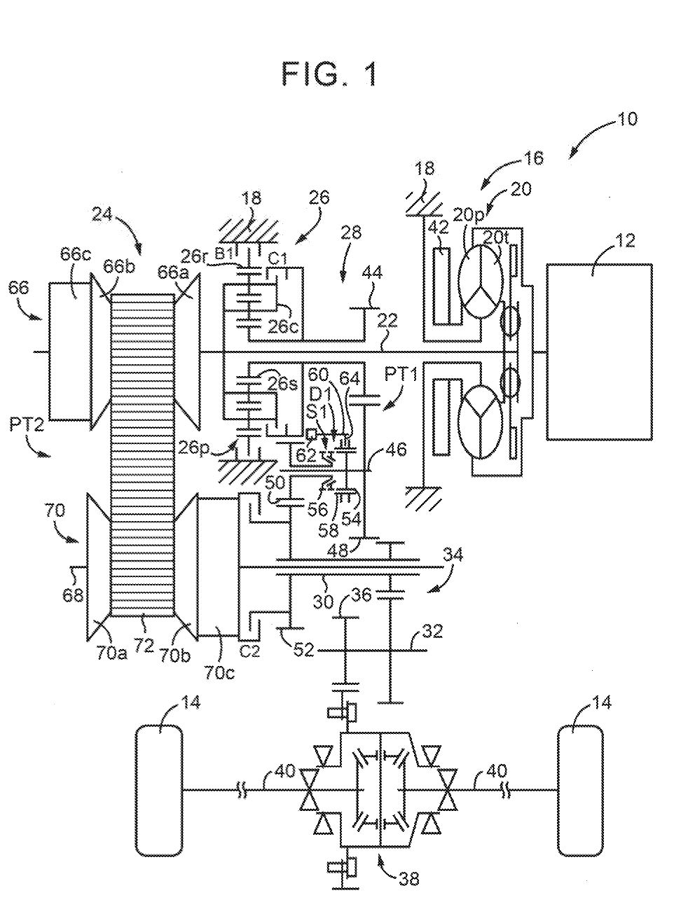

FIG. 1 illustrates the general configuration of a vehicle 10 to which the disclosure is applied. In FIG. 1, the vehicle 10 includes an engine 12, such as a gasoline engine or a diesel engine, which functions as a drive power source for traveling, drive wheels 14, and a power transmission system 16 provided between the engine 12 and the drive wheels 14. The power transmission system 16 includes a torque converter 20 as a fluid-type, transmission device coupled to the engine 12, an input shaft 22 coupled to the torque converter 20, a belt-type continuously variable transmission 24 (which will be called “CVT 24”) coupled to the input shaft 22, a forward/reverse drive switching device 26 also coupled to the input shaft 22, and a transmission mechanism 28 (which will be called “gear transmission mechanism 28”) connected to the input shaft 22 via the forward/reverse drive switching device 26. The gear transmission mechanism 28 is provided in parallel with the CVT 24, and has at least one gear ratio. The power transmission system 16 also includes an output shaft 30 as a common output rotating member of the CVT 24 and the gear transmission mechanism 28, a counter shaft 32, a reduction gear device 34, a differential gear 38, a pair of axles 40 coupled to the differential gear 38, and so forth. The reduction gear device 34 consists of a pair of meshing gears that are relatively non-rotatably provided on the output shaft 30 and the counter shaft 32, respectively. The differential gear 38 is coupled to a gear 36 that is relatively non-rotatably provided on the counter shaft 32. The above-indicated components of the power transmission system 16 are housed in a housing 18 as a non-rotary member. In the thus constructed power transmission system 16, power (Which is equivalent to torque or force when they are not particularly distinguished from each other) of the engine 12 is transmitted to the pair of drive wheels 14, via the torque converter 20, the CVT 24 or the forward/reverse drive switching device 26 and gear transmission device 28, reduction gear device 34, differential gear 38, axles 40, and so forth, in the order of description.

Thus, the power transmission system 16 includes the gear transmission mechanism 28 as a first speed change unit and the CVT 24 as a second speed change unit, which are provided in parallel between the engine 12 (equivalent to the input shaft 22 as an input rotating member to which power of the engine 12 is transmitted), and the drive wheels 14 (equivalent to the output shaft 30 as an output rotating member that delivers power of the engine 12 to the drive wheels 14). Accordingly, the power transmission system 16 includes two or more power transmission paths PT, i.e., a first power transmission path PT1 through which power of the engine 12 is transmitted toward the drive wheels 14 (namely, to the output shaft 30) via the gear transmission mechanism 28, and a second power transmission path PT2 through which the power of the engine 12 is transmitted toward the drive wheels 14 (namely, to the output shaft 30) via the CVT 24, such that these paths PT1, PT2 arc arranged in parallel between the input shaft 22 and the output shaft 30. A power transmission path PT of the power transmission system 16 is switched between the first power transmission path PT1 and the second power transmission path PT2, according to traveling conditions of the vehicle 10. Thus, the power transmission system 16 includes two or more engagement devices that switch the power transmission path PT through which power of the engine 12 is transmitted toward the drive wheels 14, between the first power transmission path PT1 and the second power transmission path PT2. The engagement devices include a first clutch C1 that connects and disconnects the first power transmission path PT1, and a second clutch C2 that connects and disconnects the second power transmission path PT2.

The torque converter 20 is provided around the input shaft 22, coaxially with the input shaft 22, and includes a pump impeller 20p coupled to the engine 12, and a turbine wheel 20t coupled to the input shaft 22. A mechanical oil pump 42, which is coupled to the pump impeller 20p, is rotated/driven by the engine 12 so as to generate hydraulic pressures for performing shift control on the CVT 24, operating the engagement devices, and supplying lubricating oil to respective parts of the power transmission system 16, and supply the hydraulic pressures to a hydraulic control circuit 80. While the engine 12 is in operation, output torque of the engine 12 is constantly applied to the input shaft 22 via the torque converter 20.

The forward/reverse drive switching device 26 is provided around the input shaft 22 in the first power transmission path PT1, coaxially with the input shaft 22, and includes a double pinion type planetary gear unit 26p, first clutch C1 and a first brake B1. The planetary gear unit 26p is a differential mechanism having three rotating elements, i.e., a carrier 26c as an input element, a sun gear 26s as an output element, and a ring gear 26r as a reaction force element. The carrier 26c is integrally coupled to the input shaft 22, and the ring gear 26r is selectively coupled to the housing 18 via the first brake B1, and the sun gear 26s is coupled to a small-diameter gear 44 that is provided around the input shaft 22, coaxially with the input shaft 22, such that it can rotate relative to the input shaft 22. The carrier 26c and the sun gear 26s are selectively coupled to each other via the first clutch C1. Accordingly, the first clutch C1 is an engagement device for selectively engaging two rotating elements, out of the above-indicated three rotating elements, for forward gear traveling, and the first brake B1 is an engagement device that selectively engages the ring gear 26r as the reaction three element with the housing 18, for reverse traveling.

The gear transmission mechanism 28 includes the small-diameter gear 44, and a large-diameter gear 48 that is provided around a gear mechanism counter shaft 46, coaxially with the counter shaft 46, and meshes with the small-diameter gear 44. The gear transmission mechanism 28 also includes an idler gear 50 that is relatively rotatably provided around the gear mechanism counter shaft 46, coaxially with the counter shaft 46, and an output gear 52 that is relatively non-rotatably provided around the output shaft 30, coaxially with the output shaft 30, and meshes with the idler gear 50. The output gear 52 has a larger diameter than the idler gear 50. With the gear transmission mechanism 28 provided on the power transmission path PT between the input shaft 22 and the output shaft 30, one speed ratio (gear position) is established or formed as a predetermined speed ratio of the gear transmission mechanism 28. Furthermore, a dog clutch D1 is provided around the gear mechanism counter shaft 46, between the large-diameter gear 48 and the idler gear 50, for selectively connecting and disconnecting the large-diameter gear 48 and the idler gear 50. The dog clutch D1, which is one of the above-mentioned engagement devices, functions as a third engagement device that is included in the power transmission system 16 and placed in a power transmission path between the forward/reverse drive switching device 26 (equivalent to the first clutch C1) and the output shaft 30 (in other words, provided closer to the output shaft 30 than the first clutch C1), for connecting and disconnecting the first power transmission path PT1. In other words, the first power transmission path PT1 is formed when the third engagement device and the first clutch C1 are engaged.

More specifically, the dog clutch D1 includes a clutch hub 54, a clutch gear 56, and a cylindrical sleeve 58. The clutch hub 54 is provided around the gear mechanism counter shaft 46, coaxially with the counter shaft 46, such that the clutch D1 cannot rotate relative to the counter shaft 46. The clutch gear 56 is disposed between the idler gear 50 and the clutch hub 54, and is fixed to the idler gear 50. The sleeve 58 is splined-fitted on the clutch hub 54, such that the sleeve 58 cannot rotate relative to the clutch hub 54 about the axis of the gear mechanism counter shaft 46, and can move relative to the clutch hub 54 in a direction parallel to the same axis. When the sleeve 58 that is constantly rotated as a unit with the clutch hub 54 is moved toward the clutch gear 56, to be brought into meshing engagement with the clutch gear 56, the idler gear 50 and the gear mechanism counter shaft 46 are connected to each other. Further, the dog clutch D1 includes a known synchromesh mechanism S1 as a synchronization mechanism, which serves to synchronize rotation when the sleeve 58 is engaged with the clutch gear 56. The dog clutch D1 constructed as described above is switched between an engaged state and a released state, when a fork shaft 60 is operated by a hydraulic actuator 62, so that the sleeve 58 slides in a direction parallel to the axis of the gear mechanism counter shaft 46, via a shift fork 64 fixed to the fork shaft 60,

The first power transmission path PT1 is formed when the dog clutch D1 and the first clutch C1 (or the first brake B1) provided closer to the input shaft 22 than the dog clutch D1 are both engaged. A forward-drive power transmission path is formed when the first clutch C1 is engaged, and a reverse-drive power transmission path is formed when the first brake B1 is engaged. In the power transmission system 16, when the first power transmission path PT1 is formed, it is placed in a power transmittable state in which power of the engine 12 can be transmitted from the input shaft 22 to the output shaft 30 via the gear transmission mechanism 28. The speed ratio γgear (which will be called “gear speed ratio”) of the first power transmission path PT1 is set to a speed ratio that is larger than the maximum speed ratio ;max of the speed ratio γcvt (which will be called “CVT speed ratio”) of the second power transmission path PT2. On the other hand, when at least the first clutch C1 and the first brake B1 are both released, or at least the dog clutch D1 is released, the first power transmission path PT1 is placed in a power transmission interrupted state.

The CVT 24 includes a primary pulley (primary sheave) 66 having a variable effective diameter and provided on the input shaft 22 that rotates along with the engine 12, a secondary pulley (secondary sheave) 70 having a variable effective diameter and provided on a rotary shaft 68 having the same axis as the output shaft 30, and a transmission belt 72 that is looped around the pulleys 66, 70. The CVT 24 transmits power via frictional force (belt gripping force) between the pulleys 66, 70 and the transmission belt 72. In the primary pulley 66, a sheave hydraulic pressure (i.e., a primary pressure Pin supplied to a primary-side hydraulic actuator 66c) supplied to the primary pulley 66 is regulated or controlled by a hydraulic control circuit 80 (see FIG. 3) driven by an electronic control unit 90 (see FIG. 3), so that a primary thrust Win (=primary pressure Pin×pressure receiving area) that changes the width of a V groove between a fixed sheave 66a and a movable sheave 66b is provided. In the secondary pulley 70, a sheave hydraulic pressure (i.e., a secondary pressure Pout supplied to a secondary-side hydraulic actuator 70c) supplied to the secondary pulley 70 is regulated or controlled by the hydraulic control circuit 80, so that a secondary thrust Wₒᵤₜ (=secondary pressure Pout×pressure receiving area) that changes the width of a V groove between a fixed sheave 70a and a movable sheave 70b is provided. In the CVT 24, the primary thrust Win (primary pressure Pin) and the secondary thrust Wout (secondary pressure Pout) are respectively controlled, so that the width of the V groove of each pulley 66, 70 is changed, and the engaging diameter (effective diameter) of the transmission belt 72 is changed. As a result, the CVT speed ratio γcvt (=primary pulley rotational speed Npri/secondary pulley rotational speed Nsec) is changed, and the frictional force between each pulley 66, 70 and the transmission belt 72 is controlled so that no slip occurs to the transmission belt 72.

The output shaft 30 is disposed around the rotary shaft 68, coaxially with the rotary shaft 68, such that the output shaft 30 can rotate relative to the rotary shaft 68. The second clutch C2 is provided closer to the drive wheels 14 (equivalent to the output shaft 30) than the CVT 24 (namely, provided between the secondary pulley 70 and the output shaft 30), and selectively connects/disconnects the secondary pulley 70 (rotary shaft 68) with/from the output shaft 30. The second power transmission path PT2 is formed by engaging the second clutch C2. In the power transmission system 16, when the second power transmission path PT2 is formed, it is placed in a power transmittable state in which power of the engine 12 can be transmitted from the input shaft 22 to the output shaft 30 via the CVT 24. On the other hand, when the second clutch C2 is released, the second power transmission path PT2 is placed in a neutral state.

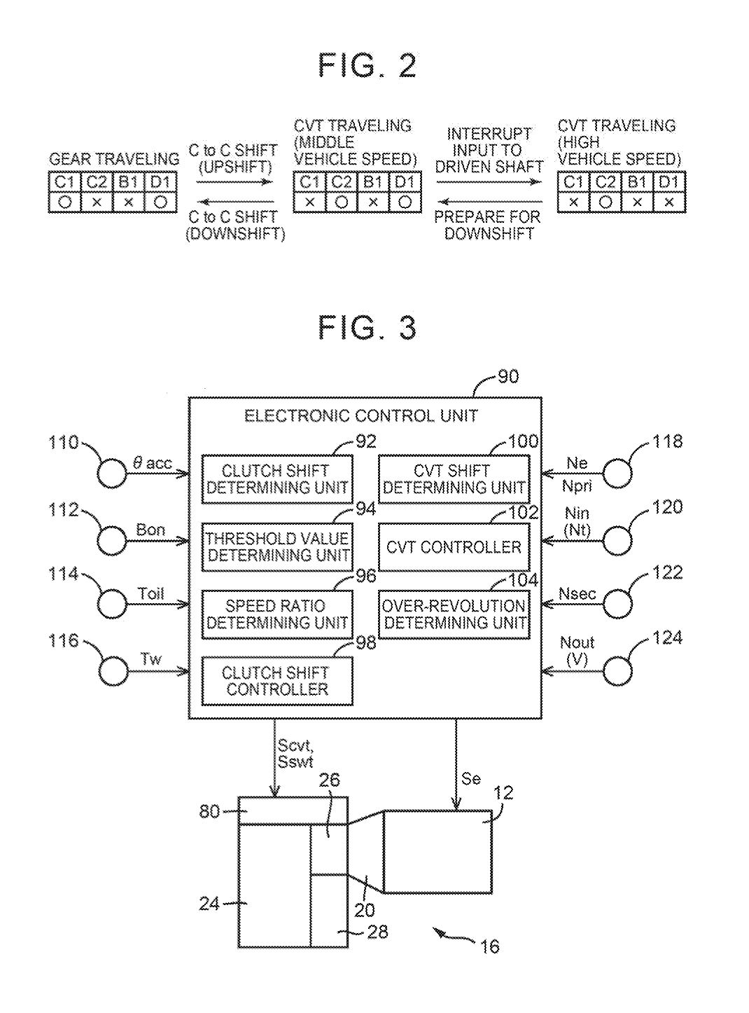

Operation of the power transmission system 16 will be described below. FIG. 2 is a view useful for explaining switching of traveling patterns (traveling modes) of the power transmission system 16, using an engagement table of the engagement devices for each of the traveling patterns switched by the electronic control unit 90. In FIG. 2, “C1” corresponds to an operating state of the first clutch C1, “C2” corresponds to an operating state of the second clutch C2, “B1” corresponds to an operating state of the first brake B1, “D1” corresponds to an operating state of the dog clutch D1, “O” indicates an engaged (connected) state, and “x” indicates a released (disconnected) state.

FIG. 3 is a view useful for explaining control functions and a principal part of a control system for various controls performed in the vehicular power transmission system 16. In FIG. 3, the power transmission system 16 includes the electronic control unit 90. Thus, FIG. 3 is a view showing an input/output system of the electronic control unit 90, and a functional block diagram illustrating a principle part of control functions performed by the electronic control unit 90. The electronic control unit 90 includes a so-called microcomputer including CPU, RAM, ROM, input/output interface, etc., for example, and the CPU performs signal processing according to programs stored in the ROM in advance, while utilizing the temporary storage function of the RAM, so as to perform various controls on the vehicular power transmission system 16. For example, the electronic control unit 90 performs output control of the engine 12, shift control of the CVT 24, switching control of the traveling patterns of the power transmission system 16, and so forth. The electronic control unit 90 is divided into and constituted by sub-units for engine control, hydraulic control, etc., as needed.

Various actual values based on detection signals of various sensors included in the vehicle 10 are supplied to the electronic control unit 90. The sensors include, for example, various rotational speed sensors 118, 120, 122, 124, accelerator pedal stroke sensor 110, brake switch 112, oil temperature sensor 114, engine coolant temperature sensor 116, and so forth. The actual values include, for example, the accelerator pedal stroke signal θacc (%), brake operation signal Bon, oil temperature Toil (° C.) of hydraulic oil, engine coolant temperature Tw (° C.), engine speed Ne (rpm), primary pulley rotational speed Npri (rpm) as input shaft rotational speed Nin (rpm) that is also called turbine rotational speed Nt (rpm), secondary pulley rotational speed Nsec (rpm) as rotational speed of the rotary shaft 68, and the output shaft rotational speed Nout (rpm) corresponding to the vehicle speed V. The electronic control unit 90 outputs an engine output control command signal Se for output control of the engine 12, hydraulic control command signal Scvt for hydraulic control in connection with shifting of the CVT 24, hydraulic control command signal Swt for controlling the first clutch C1, first brake B1, second clutch C2, and the dog clutch D1, which are associated with switching of the traveling patterns of the power transmission system 16, and so forth. For example, as the hydraulic control command signal Sswt, a command signal (hydraulic command) for driving each solenoid valve that regulates each hydraulic pressure supplied to each hydraulic actuator of the first clutch C1, first brake B1, second clutch C2, and the dog clutch D1 is generated to the hydraulic control circuit 80.

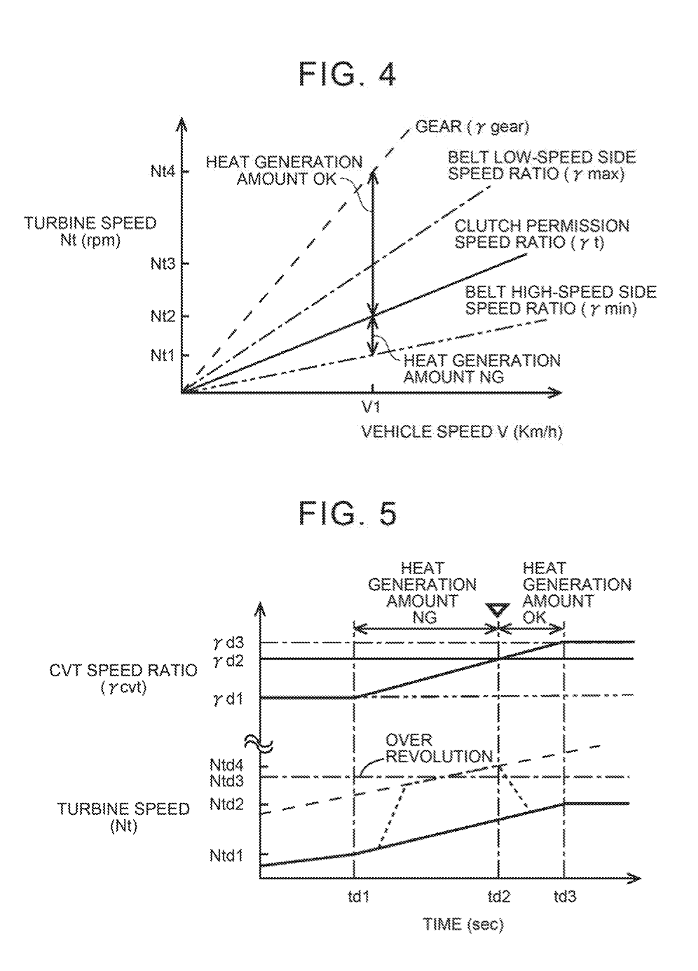

FIG. 4 shows one example of the relationship between the turbine rotational speed Nt or the primary sheave rotational speed Npri, and the vehicle speed V corresponding to the output shaft rotational speed Nout, on an upshift or a downshift for switching between the first power transmission path PT1 and the second power transmission path PT2, through clutch-to-clutch shifting (which will be referred to as “clutch shifting”) of the clutches C1, C2. Each straight line shown in FIG. 4 indicates speed ratio γ, and the gear speed ratio γgear in the case where the first power transmission path PT1 is formed is indicated by a broken line. The CVT speed ratio γcvt, namely, the speed ratio γ in the case where the second power transmission path PT2 is formed, can be set within a region between a belt low-speed-side, speed ratio γmax indicated by a one-dot chain line, and a belt high-speed-side speed ratio γmin indicated by a two-dot chain line. Also, a predetermined threshold value of the speed ratio γ above which clutch shift control is permitted is indicated by a solid line. In the following description, the predetermined threshold value will be referred to as “clutch permission speed ratio γt”. The clutch permission speed ratio γt is determined such that, if a difference in rotation ΔNt as a change of the turbine rotational speed Nt on an upshift or a downshift at the vehicle speed V1 is equal to or smaller than a predetermined value, namely, a difference between Nt2 and Nt4 in FIG. 4, the amount of heat generated during clutch shifting of the clutches C1, C2 is within a range in which reduction of the durability of the friction material of the clutches C1, C2 can he curbed. If the CVT speed ratio γcvt is smaller than γt, the clutch shift control is not performed since the durability of the friction material is reduced due to a large amount of heat generated at the clutches C1, C2. In this embodiment, the clutch permission speed ratio γt is set to a predetermined fixed value irrespective of the vehicle speed V, for example.

The amount of heat ΔQ generated per unit time during an upshift or a downshift is expressed by Eq. (1) below Accordingly, when the CVT speed ratio γcvt is on the high-speed side, or γmin side, the difference in rotation ΔNt is large, and the shift time tc is long; therefore, the quantity of heat ΔQ generated per unit time is increased. In clutch shifting, the speed is changed at the clutch to be engaged in the inertia phase on an upshift, and the speed is changed at the clutch to be released in the inertia phase on a downshift; therefore, transmission torque on an upshift is larger than that on a downshift, and the clutch permission speed ratio γt assumes different values between upshift and downshift.

Quantity of heat ΔQ per unit time=(difference in rotation ΔNt×clutch transmission torque Tc/area of frictional material)×shift time tc (1)

FIG. 5 is a time chart showing one example of change of the turbine rotational speed Nt with time, during a downshift for switching between the first power transmission path PT1 and the second power transmission path PT2, through clutch shifting of the clutches C1, C2. In the upper section of FIG. 5 indicating the CVT speed ratio γcvt, γd3 indicated by a one-dot chain line denotes the maximum speed ratio γmax, and γd2 indicated by a thin solid line denotes the clutch permission speed ratio γt, while γd1 indicated by a two-dot chain line denotes the γcvt speed ratio γcvt at time td1 at which the accelerator pedal is depressed, and a clutch shift control start condition is satisfied. Also, the actual change of the CVT speed ratio γcvt, or change of the CVT speed ratio γcvt in the case of switching from belt shifting to gear shifting, is indicated by a thick solid line. In the lower section of FIG. 5 indicating the turbine rotational speed Nt, the turbine rotational speed Nt in gear shifting after the downshift is indicated by a broken line, and the turbine rotational speed Nt calculated from the CVT speed ratio γcvt and the output shaft rotational speed Nout is indicated by a solid line. A one-dot chain line in the lower section of FIG. 5 indicates an over-revolution rotational speed Neo (rpm) that is set in advance so as to restrict over-revolution of the engine 12, so that the rotational speed Ne of the engine 12 does riot increase to be higher than this rotational speed. At time td1, the accelerator pedal is depressed, and the clutch shift control start condition is satisfied, so that the CVT speed ratio γcvt starts increasing toward the maximum speed ratio γmax. Meanwhile, the turbine rotational speed Nt in gear shifting after the downshift, which is indicated by the broken line, also increases. At time td2, the CVT speed ratio γcvt reaches γd2, or the clutch permission speed ratio γt, and the amount of heat generated at the clutches C1, C2 is within the range where shifting is permitted. However, the turbine rotational speed Nt, or the engine speed Ne, reaches Ntd4, and the engine speed Ne exceeds Ntd3, i.e., the over-revolution rotational speed Neo as the upper limit. Therefore, while a condition that permits the downshift, in connection with the amount of heat generated at the clutches C1, C2, is satisfied, the downshift is not carried out since the engine speed Ne exceeds the over-revolution rotational speed Neo, and the turbine rotational speed Nt at time td3 becomes equal to Ntd2.

FIG. 3 also includes the functional block diagram useful for explaining a principal part of control functions of the electronic control unit 90. A clutch shift determining unit 92 determines whether clutch shift control needs to be started, using a condition that the accelerator pedal stroke θacc as the operation amount of the accelerator pedal (not shown) is equal to or larger than a predetermined value θa. The clutch shift determining unit 92 also determines whether clutch shift control, or an upshift or a downshift, needs to be performed, based on a pre-stored map obtained from the relationship among the output shaft rotational speed Nout corresponding to the vehicle speed V, turbine rotational speed Nt, and the accelerator pedal stroke θacc. If it is determined that the clutch shift control needs to be performed, a speed ratio determining unit 96 determines whether the CVT speed ratio γcvt is equal to or smaller than the maximum speed ratio γmax. A CVT shift determining unit 100 sets a flag indicating that belt shifting is being executed (F=1). A CVT controller 102 increases the CVT speed ratio γCVT at a predetermined rate or speed. The speed ratio determining unit 96 determines completion of belt shifting, when it determines that the CVT speed ratio γcvt reaches the maximum speed ratio γmax. Once the belt shifting is completed, the CVT shift determining unit 100 resets the flag indicating that the belt shifting is being executed (F=0). An over-revolution determining unit 104 determines (estimates) whether the engine speed Ne (=output shaft rotational speed Nout before shifting×gear speed ratio γgear) after clutch shifting of the clutches C1, C2 will be equal to or higher than the over-revolution rotational speed Neo that is set in advance for determination of excessive rotation.

In clutch shift control, the clutch shift determining unit 92 determines whether clutch shift control needs to be started, using a condition that the accelerator pedal stroke θacc as the operation amount of the accelerator pedal (not shown) is equal to or larger than the predetermined value θa, and further determines whether clutch shift control, or an upshift or a downshift, needs to be performed, based on the pre-stored map obtained from the relationship among the output shaft rotational speed Nout corresponding to the vehicle speed V, turbine rotational speed Nt, and the accelerator pedal stroke θacc. If it is determined that the clutch shift control needs to be performed, the clutch shift determining unit 92 checks if the belt shift execution flag is set (F=1). When the belt shift execution flag is reset (F=0), the speed ratio determining unit 96 determines whether the CVT speed ratio γcvt is equal to the maximum speed ratio γmax, namely, determines whether the CVT speed ratio γcvt has already reached the maximum speed ratio γmax, at which there is no possibility of reduction of the durability of the friction material due to a large amount of heat generated at the clutches C1, C2, even if the clutch shift control is performed. If the CVT speed ratio γCVT γcvt has not reached the maximum speed ratio γmax, the clutch shift determining unit 92 holds or maintains a condition where clutch shift control is not executed, until it confirms that the belt shift execution flag is set (F=1), so that belt shifting is surely carried out. If the speed ratio determining unit 96 confirms that the CVT speed ratio γcvt is equal to the maximum speed ratio γmax, a clutch shift controller 98 performs clutch shift control of the clutches C1, C2. When the belt shift execution flag is set (F=1), the speed ratio determining unit 96 determines whether the CVT speed ratio γcvt is equal to or larger than the clutch permission speed ratio γt. If the CVT speed ratio γCVT has not reached the clutch permission speed ratio γt, the clutch shift controller 98 holds the condition where clutch shift control is not executed. If it is determined that the CVT speed ratio γcvt is equal to or larger than the clutch permission speed ratio γt, the clutch shift controller 98 starts clutch shift control for switching between the first power transmission path PT1 and the second power transmission path PT2. Preferably, the clutch shift controller 98 inhibits clutch shift control when the over-revolution determining unit 104 determines (predicts) that the engine speed Ne (=the current output shaft rotational speed Nout×the gear speed ratio γgear) after clutch shifting of the clutches C1, C2 will be equal to or higher than the over-revolution rotational speed Neo, but the clutch shift controller 98 executes the clutch shift control when the engine speed after clutch shifting will be lower than the over-revolution rotational speed Neo.

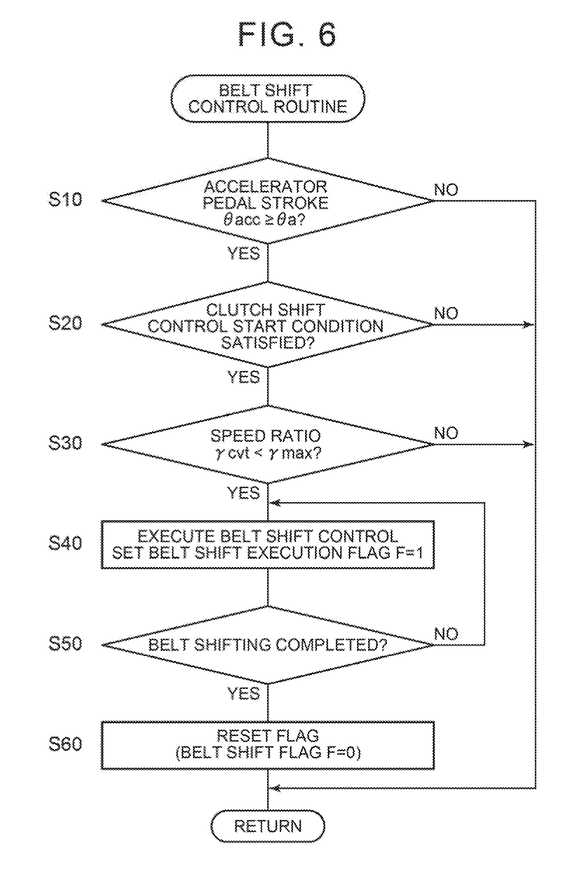

FIG. 6 is a flowchart illustrating a principal part of control operation of the electronic control unit 90, and shows a routine of belt shift control. In step S10 corresponding to a function of the clutch shift determining unit 92, it is determined whether the accelerator pedal is depressed so that the accelerator pedal stroke θacc becomes equal to or larger than the threshold value θa. If a negative decision (NO) is obtained in step S10, step S10 is repeatedly executed. If an affirmative decision (YES) is obtained in step S10, it is determined in step S20 corresponding to a function of the clutch shift determining unit 92 whether a clutch shift control start condition is satisfied. If a negative decision (NO) is obtained in step S20, steps S10 and S12 are repeatedly executed. If an affirmative decision (YES) is obtained in step S20, it is determined in step S30 corresponding to a function of the speed ratio determining unit 96 whether the CVT speed ratio γcvt is smaller than γmax. If a negative decision (NO) is obtained in step S30, steps S10, S20 and S30 are repeatedly executed. If an affirmative decision (YES) is obtained in step S30, belt shift control is executed, and the belt shift execution flag is set (F=1), in step S40 corresponding to a function of the CVT shift determining unit 100 and the CVT controller 102. In step S50 corresponding to a function of the speed ratio determining unit 96, it is determined whether belt shifting is completed. If a negative decision (NO) is obtained in step S50, execution of the belt shift control and setting of the belt shift execution flag (F=1) are continued. If an affirmative decision (YES) is obtained in step S50, the belt shift execution flag is reset (F=0), in step S60 corresponding to a function of the CVT shift determining unit 100.

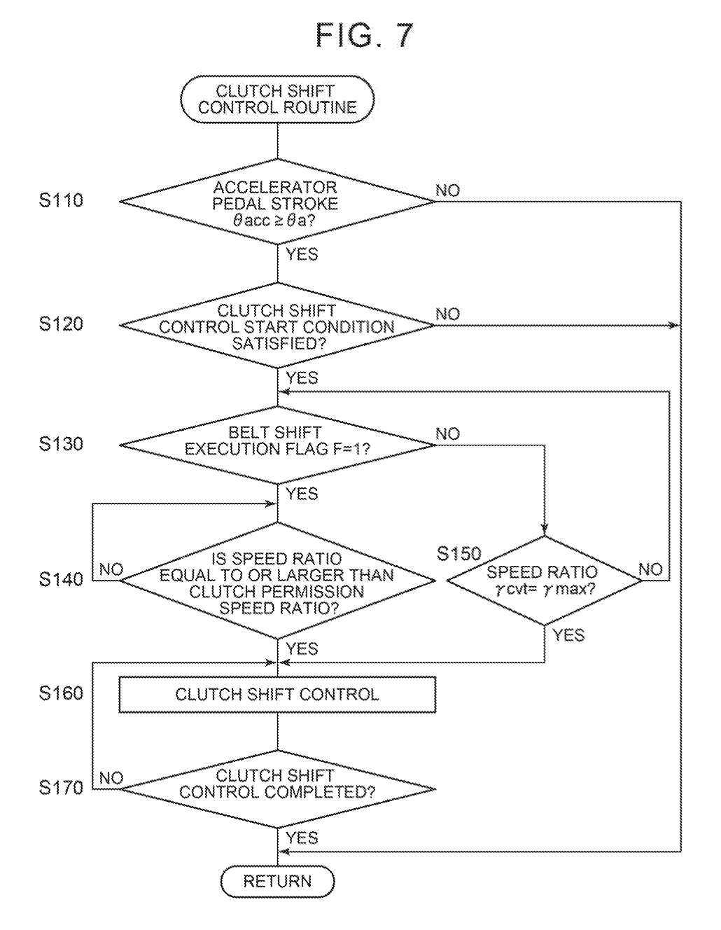

FIG. 7 is a flowchart illustrating a principal part of control operation of the electronic control unit 90, and shows a routine of clutch shift control. In step S110 corresponding to a function of the clutch shift determining unit 92, it is determined whether the accelerator pedal is depressed so that the accelerator pedal stroke θacc becomes equal to or larger than the threshold value θa. If a negative decision (NO) is obtained in step S110, step S110 is repeatedly executed. If an affirmative decision (YES) is obtained in step S110, it is determined in step S120 corresponding to a function of the clutch shift determining unit 92 whether a clutch shift control start condition is satisfied. If a negative decision (NO) is obtained in step S120, steps S110 and S120 are repeatedly executed. If an affirmative decision (YES) is obtained in step S120, it is determined in step S130 corresponding to a function of the clutch shift determining unit 92 whether the belt shift execution flag is set (F=1). If a negative decision (NO) is obtained in step S130, it is determined in step S150 corresponding to a function of the speed ratio determining unit 96 whether the CVT speed ratio γcvt is equal to the maximum speed ratio γmax. If a negative decision (NO) is obtained in step S150, steps S130 and S150 are repeatedly executed. If an affirmative decision (YES) is obtained in step S150, clutch shift control of the clutches C1, C2 is performed, in step S160 corresponding to a function of the clutch shift controller 98. In step S170 corresponding to a function of the clutch shift controller 98, it is determined whether clutch shift control is completed. If a negative decision (NO) is obtained in step S170, clutch shift control of the clutches C1, C2 in step S160 is continued. If an affirmative decision (YES) is obtained in step S170, the clutch shift control routine ends. Returning to step S130, if an affirmative decision (YES) is obtained in step S130, namely, if the belt shift execution flag is set (F=1), it is determined in step S140 corresponding to a function of the speed ratio determining unit 96 Whether the CVT speed ratio γcvt is equal to or larger than the clutch permission speed ratio γt. If a negative decision (NO) is obtained in step S140, step S140 is repeatedly executed. If an affirmative decision (YES) is obtained in step S140, the above steps S160 and S170 are repeated. If an affirmative decision (YES) is obtained in step S170, the clutch shift control routine ends.

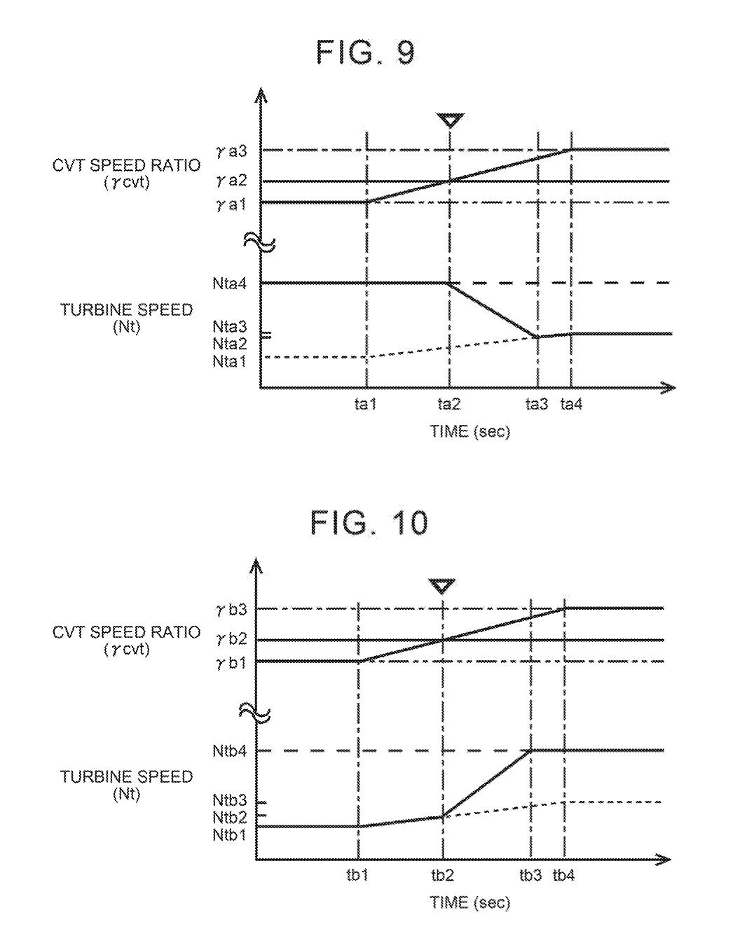

FIG. 9 is a time chart showing one example of changes of the CVT speed ratio γcvt and the turbine rotational speed Nt with elapsed time, during an upshift, or switching from the first power transmission path PT1 to the second power transmission path PT2. In the upper section of FIG. 9 indicating the CVT speed ratio γcvt, γa3 indicated by a one-dot chain line denotes the maximum speed ratio γmax, and γa2 indicated by a thin solid line denotes the clutch permission speed ratio γt, while γa1 indicated by a two-dot chain line denotes the CVT speed ratio γcvt at time ta1 when the accelerator pedal is depressed, and the clutch shift control start condition is satisfied. The actual change of the CVT speed ratio γcvt, or change of the CVT gear ratio γcvt at the time of switching from gear shifting to belt shifting, is indicated by a thick solid line. In the lower section of FIG. 9 indicating the turbine rotational speed Nt, a broken line indicates the turbine rotational speed Nta4 in gear shifting on an upshift, and a dotted line indicates the turbine rotational speed calculated from the CVT speed ratio γcvt and the output shaft rotational speed bout. Also, the actual change of the turbine rotational speed Nt, or change of the turbine rotational speed Nt in the case of switching from gear shifting to belt shifting, is indicated by a thick solid line. Before time ta1, the CVT speed ratio γcvt is equal to γa1, and the turbine rotational speed Nt is equal to Nta4. At time ta1, the accelerator pedal is depressed, and the clutch shift control start condition is satisfied, so that the CVT speed ratio γcvt starts increasing toward the maximum speed ratio γmax. On the other hand, the turbine rotational speed Nt is kept at Nta4 since the gear shifting is continued. At time ta2, clutch shifting is started once the CVT speed ratio γcvt reaches γa2, or the clutch permission speed ratio γt. As the clutch shifting proceeds, the turbine rotational speed Nt is reduced. At time ta3, the gear shifting is switched to the belt shifting, and the turbine rotational speed Nt becomes equal to the rotational speed Nta2 calculated from the CVT speed ratio γcvt and the output shaft rotational speed Nout. At time ta4 at which the CVT speed ratio γcvt becomes equal to γa3, or the maximum speed ratio γmax, the turbine rotational speed Nt becomes equal to Nta3, and the upshift is completed.

FIG. 10 is a time chart showing one example of changes of the CVT speed ratio γcvt and the turbine rotational speed Nt with elapsed time, during a downshift, or switching from the second power transmission path PT2 to the first power transmission path PT1. In the upper section of FIG. 10 indicating the CVT speed ratio γcvt, γb3 indicated by a one-dot chain line denotes the maximum speed ratio γmax, and γb2 indicated by a thin solid line denotes the clutch permission speed ratio γt, while γb1 indicated by a two-dot chain line denotes the CVT speed ratio γcvt at time tbl when the accelerator pedal is depressed, and the clutch shift control start condition is satisfied. The actual change of the CVT speed ratio γcvt, or change of the CVT speed ratio γcvt in the ease of switching from belt shifting to gear shifting, is indicated by a thick solid line, in the lower section of FIG. 10 indicating the turbine rotational speed Nt, a broken line indicates the turbine rotational speed Ntb4 in gear shifting after the downshift, and a dotted line indicates the turbine rotational speed Nt calculated from the CVT speed ratio γcvt and the output shaft rotational speed Nout. The actual change of the turbine rotational speed Nt, or change of the turbine rotational speed Nt in the case of switching from belt shifting to gear shifting, is indicated by a thick solid line. Before time tb1, the CVT speed ratio γcvt is equal to γb1, and the turbine rotational speed Nt is equal to Ntb1. At time tb1, the accelerator pedal is depressed, and the clutch shift control start condition is satisfied, so that the CVT speed ratio γcvt starts increasing toward the maximum speed ratio γmax. On the other hand, the turbine rotational speed Nt increases as the CVT speed ratio γcvt increases toward the maximum speed ratio γmax. At time tb2 at which the CVT speed ratio γcvt reaches γb2, or the clutch permission speed ratio γt, clutch shifting is started. The turbine rotational speed Nt increases with clutch shifting, and, at time tb3, the belt shifting is switched to the gear shifting, and the turbine rotational speed Nt becomes equal to the rotational speed Ntb4 calculated from the gear speed ratio γgear and the output shaft rotational speed Nout. At this point, the downshift is completed.

As described above, the vehicular power transmission system 16 of this embodiment includes i) the CVT 24 having the primary pulley 66 provided on the input shaft 22 to which torque delivered from the engine 12 is transmitted, the secondary pulley 70 provided on the output shaft 30 that delivers torque to the drive wheels 14, and the transmission belt 72 looped around the primary pulley 66 and the secondary pulley 70, ii) the gear transmission mechanism 28 having at least one gear speed ratio γgear, and iii) the clutches C1, C2 for switching between the first power transmission path PT1 through which torque delivered from the engine 12 can be transmitted to the output shaft 30 via the gear transmission mechanism 28, and the second power transmission path PT2 through which the torque can be transmitted to the output shaft 30 via the CVT 24. In this power transmission system 16, when the speed ratio γcvt of the CVT 24 is equal to or larger than the predetermined threshold value, or clutch permission speed ratio γt, the power transmission path is switched between the first power transmission path PT1 through which the torque of the engine 12 can be transmitted to the output shaft 30 via the gear transmission mechanism 28, and the second power transmission path PT2 through which the torque of the engine 12 can be transmitted to the output shaft 30 via the CVT 24. Thus, when the power transmission path is switched between the first power transmission path PT1 through which the torque of the engine 12 can be transmitted to the output shaft 30 via the gear transmission mechanism 28, and the second power transmission path PT2 through which the torque of the engine 12 can be transmitted to the output shaft 30 via the CVT 24, the speed ratio γcvt of the CVT 24 is changed toward the low-gear side, or the maximum speed ratio γmax, and then shift control is started. Therefore, it is possible to effectively curb reduction of the durability of the friction material used in the clutches C1, C2, which would occur in the case where shift control is started in a condition where a difference between the rotational speed Nin of the input shaft 22 and the rotational speed Nout of the output shaft 30 is large.

Next, a second embodiment of the disclosure will be described. In the following description, the same reference numerals are assigned to portions or components common to this embodiment and the above embodiment, and further explanation of these portions or components will not be provided.

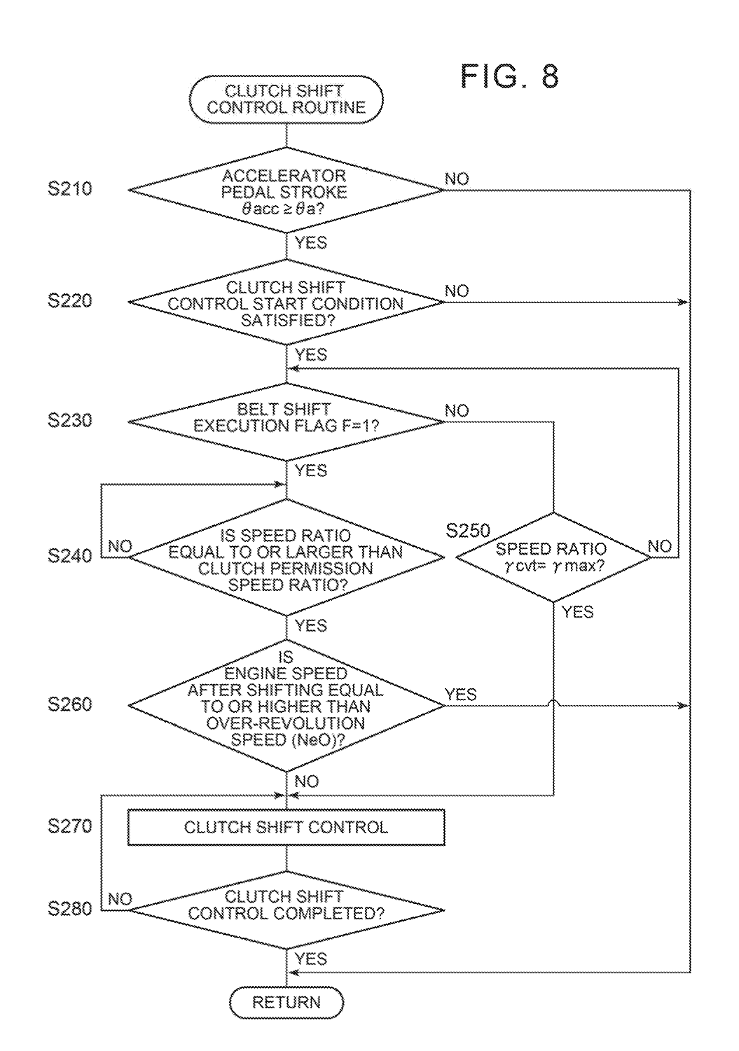

FIG. 8 is a flowchart illustrating a principal part of control operation of the electronic control unit 90, and shows a routine of clutch shift control. Steps other than step S260 corresponding to a function of the over-revolution determining unit 104 are identical with those of FIG. 7, and only a part of the control routine of FIG. 8 executed after an affirmative decision (YES) is obtained in step S230 will be described. If an affirmative decision (YES) is obtained in step S230 corresponding to a function of the clutch shift determining unit 92, namely, when the belt shift execution flag is set (F=1), it is determined in step S240 corresponding to a function of the speed ratio determining unit 96 whether the CVT speed ratio γcvt is equal to or larger than the clutch permission speed ratio γt. If a negative decision (NO) is obtained in step S240, step S240 is repeatedly executed. If an affirmative decision (YES) is obtained in step S240, it is determined (predicted), in step S260 corresponding to a function of the over-revolution determining unit 104, whether the engine speed Ne (=the current output shaft rotational speed Nout×the gear speed ratio γgear) that increases due to a downshift after clutch shifting will be equal to or higher than a preset over-revolution rotational speed Neo. If an affirmative decision (YES) is obtained in step S260, namely, if the engine speed Ne after clutch shifting will be equal to or higher than the over-revolution rotational speed Neo, step S210 and subsequent steps are repeatedly executed. If a negative decision (NO) is obtained in step S260, namely, if the engine speed Ne after clutch shifting will be lower than the over-revolution rotational speed Neo, clutch shift control of the clutches C1, C2 is performed, in step S270 corresponding to a function of the clutch shift controller 98. Also, in step S280 corresponding to a function of the clutch shift controller 98, it is determined whether clutch shift control is completed. If a negative decision (NO) is obtained in step S280, the clutch shift control of the clutches C1, C2 in step S270 is continued. If an affirmative decision (YES) is obtained in step S280, the clutch shift control routine ends.

Thus, as in the above-described first embodiment, when the speed ratio γcvt of the CVT 24 is equal to or larger than the predetermined threshold value, or the clutch permission speed ratio γt, the power transmission path PT is switched between the first power transmission path PT1 through which the torque of the engine 12 can be transmitted to the output shaft 30 via the gear transmission mechanism 28, and the second power transmission path PT2 through which the torque of the engine 12 can be transmitted to the output shaft 30 via the CVT 24. Thus, when the power transmission path PT is switched between the first power transmission path PT1 through which the torque of the engine 12 can be transmitted to the output shaft 30 via the gear transmission mechanism 28, and the second power transmission path PT2 through which the torque of the engine 12 can be transmitted to the output shaft 30 via the CVT 24, the speed ratio γcvt of the CVT 24 is changed toward the low-gear side, or the maximum speed ratio γmax, and then, the shift control is started. Therefore, it is possible to effectively curb reduction of the durability of the friction material used in the clutches C1, C2, which would occur in the case where shift control is started in a condition where a difference between the rotational speed Nin of the input shaft 22 and the rotational speed Nout of the output shaft 30 is large. Further, when the rotational speed Ne of the engine 12 after switching between the first power transmission path PT1 and the second power transmission path PT2 is expected to be equal to or higher than the over-revolution rotational speed Neo that is set in advance for curbing excessive rotation, switching between the first power transmission path PT1 and the second power transmission path PT2 is inhibited, so that reduction of the durability of the frictional material used in the clutches C1, C2 is further effectively curbed.

A third embodiment of the disclosure will be described. In the following description, the same reference numerals are assigned to portions or components common to this embodiment and the above embodiments, and further explanation of these portions or components will not be provided.

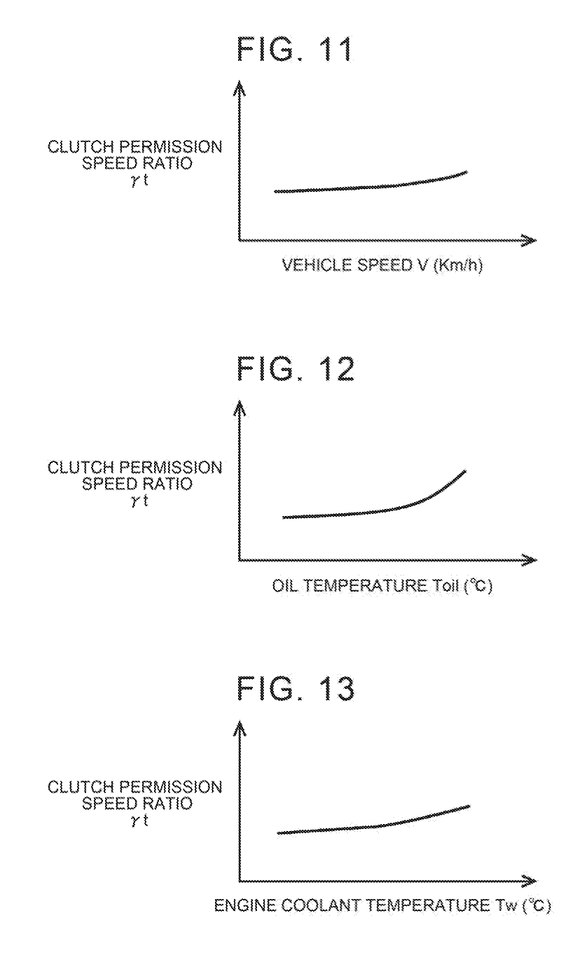

FIG. 11 shows the relationship between the clutch permission speed ratio γt and the vehicle speed V. In the above embodiments, the clutch permission speed ratio γt is a fixed value that is constant regardless of the vehicle speed V or the output shaft rotational speed Nout. However, the clutch permission speed ratio γt may be set based on the relationship (map) obtained in advance by experiment, using the vehicle speed V as a variable. As compared with the case where the clutch permission speed ratio γt is a fixed value, it is possible to set the clutch permission speed ratio γt with higher accuracy and more effectively curb reduction of the durability of the friction material used in the clutches C1, C2, which would occur in the case where shift control is started in a condition where a difference between the rotational speed Nin of the input shaft 22 and the rotational speed Nout of the output shaft 30 is large. In the functional block diagram of FIG. 3 used for explaining a principal part of control functions, the threshold value determining unit 94 sets the clutch permission speed ratio γt, based on the vehicle speed V.

Next, a fourth embodiment of the disclosure will be described. In the following description, the same reference numerals are assigned to portions or components common to this embodiment and the above embodiments, and further explanation of these portions or components will not be provided.

FIG. 12 shows the relationship between the clutch permission speed ratio γt and the oil temperature Toil of the hydraulic oil. While the clutch permission speed ratio γt is set to a fixed value in the first and second embodiments, the clutch permission speed ratio γt may be set based on the relationship (map) obtained in advance by experiment, using the oil temperature Toil as a variable. In this case, as compared with the case where the clutch permission speed ratio γt is a fixed value, it is possible to set the clutch permission speed ratio γt with higher accuracy, and more effectively curb reduction of the durability of the friction material used in the clutches C1, C2, which would occur in the case where shift control is started in a condition where a difference between the rotational speed Nin of the input shaft 22 and the rotational speed Nout of the output shaft 30 is large. In the functional block diagram of FIG. 3 used for explaining a principal part of control functions, the threshold value determining unit 94 sets the clutch permission speed ratio γt, based on the oil temperature Toil.

Further, a fifth embodiment of the disclosure will be described. In the following description, the same reference numerals are assigned to portions or components common to this embodiment and the above embodiments, and further explanation of these portions or components will not be provided.

FIG. 13 shows the relationship between the clutch permission speed ratio γt and the engine coolant temperature Tw. While the clutch permission speed ratio γt is a fixed value in the first and second embodiments, the clutch permission speed ratio γt may be set based on the relationship (map) obtained in advance by experiment, using the engine coolant temperature Tw as a variable. In this case, as compared with the case where the clutch permission speed ratio γt is a fixed value, it is possible to set the clutch permission speed ratio r with higher accuracy, and more effectively curb reduction of the durability of the friction material used in the clutches C1, C2, which would occur in the ease where shift control is started in a condition where a difference between the rotational speed Nin of the input shaft 22 and the rotational speed Nout of the output shaft 30 is large. In the functional block diagram of FIG. 3 used for explaining a principal part of control functions, the threshold value determining unit 94 sets the clutch permission speed ratio γt, based on the engine coolant temperature Tw.

While some embodiments of the disclosure have been described in detail based on the drawings, the disclosure may be embodied in other forms.

In the third, fourth and fifth embodiments as described above, the clutch permission speed ratio γt is set, based on the vehicle speed V, oil temperature Toil, and the engine coolant temperature Tw, respectively. However, the clutch permission speed ratio γt may be set based on a combination of two or more of the vehicle speed V, oil temperature Toil, and the engine coolant temperature Tw, or all of these variables.

In the above embodiments, clutch shift control, or clutch-to-clutch control, is performed, when the CVT speed ratio γcvt is equal to or larger than the clutch permission speed ratio γt, after the clutch shift control start condition is satisfied. In this clutch shift control, when the CVT speed ratio γcvt is smaller than the clutch permission speed ratio γt, change of the torque phase prior to change of the inertia phase may be started, and the inertia phase may be changed, or the turbine rotational speed Nt may be changed, at the time when the CVT speed ratio γcvt becomes equal to or larger than the clutch permission speed ratio γt. Also, change of the torque phase prior to change of the inertia phase may be started, after the CVT speed ratio γcvt exceeds the clutch permission speed ratio γt.

In the above embodiments, it is determined whether the clutch shift control start condition is satisfied, based on the pre-stored map obtained from the relationship among the output shaft rotational speed Nout corresponding to the vehicle speed V, turbine rotational speed Nt, and the accelerator pedal stroke θacc. However, it may be determined whether a clutch shift control start condition is satisfied, using a combination of any of the throttle opening, engine torque, and input torque, in place of the accelerator pedal stroke θacc, and the vehicle speed V in place of the output shaft rotational speed Nout, for example.

While the engine 12 is illustrated by way of example as the drive power source in the above embodiments, the disclosure is not limited to the use of the engine 12 as the drive power source. For example, another power source, such as an electric motor, may be employed alone, or in combination with the engine 12, as the driving power source. While power of the engine 12 is transmitted to the input shaft 22 via the torque converter 20, the disclosure is not limited to this arrangement. For example, another fluid-type transmission device, such as a fluid coupling having no torque amplifying function, may be used, in place of the torque converter 20. Also, the fluid-type transmission device may not be necessarily provided.

It is to be understood that the above embodiments are mere examples, and that the disclosure may be embodied with various changes or improvements, based on the knowledge of those skilled in the art.

What is claimed is:

1. A control system for a vehicular power transmission system,
the vehicular power transmission system including a belt-type continuously variable transmission, a transmission mechanism having at least one gear ratio, and a clutch mechanism,
the belt-type continuously variable transmission including a primary pulley provided on an input shaft to which torque delivered from a drive power source is transmitted, a secondary pulley provided on an output shaft that delivers the torque to drive wheels, and a transmission belt looped around the primary pulley and the secondary pulley,
the clutch mechanism being configured to switch a torque transmission path between a first transmission path through which the torque delivered from the drive power source can be transmitted to the output shaft via the transmission mechanism, and a second transmission path through which the torque can be transmitted to the output shaft via the belt-type continuously variable transmission,
the control system comprising
an electronic control unit configured to switch the torque transmission path between the first transmission path and the second transmission path, when a speed ratio of the belt-type continuously variable transmission is equal to or larger than a predetermined threshold value.

2. The control system according to claim 1, wherein
the electronic control unit is configured to change the threshold value based on a vehicle speed, according to a pre-stored relationship.

3. The control system according to claim 1, wherein
the electronic control unit is configured to change the threshold value based on an oil temperature within the vehicular power transmission system, according to a pre-stored relationship.

4. The control system according to claim 1, wherein
the drive power source comprises an engine, and the electronic control unit is configured to change the threshold value based a coolant temperature of the engine, according to a pre-stored relationship.

5. The control system according to claim 1, wherein
the drive power source comprises an engine, and the electronic control unit is configured to inhibit switching of the torque transmission path, when a rotational speed of the engine after switching of the torque transmission path is expected to be equal to or higher than an over-revolution rotational speed that is set in advance for curbing excessive rotation.

6. A control method for a vehicular power transmission system,
the vehicular power transmission system including a belt-type continuously variable transmission, a transmission mechanism having at least one gear ratio, a clutch mechanism, and an electronic control unit,
the belt-type continuously variable transmission including a primary pulley provided on an input shaft to which torque delivered from a drive power source is transmitted, a secondary pulley provided on an output shaft that delivers the torque to drive wheels, and a transmission belt looped around the primary pulley and the secondary pulley,
the clutch mechanism being configured to switch a torque transmission path between a first transmission path through which the torque delivered from the drive power source can be transmitted to the output shaft via the transmission mechanism, and a second transmission path through which the torque can be transmitted to the output shaft via the belt-type continuously variable transmission,
the control method comprising:
determining, by the electronic control unit, whether a speed ratio of the belt-type continuously variable transmission is equal to or larger than a predetermined threshold value; and
switching, by the electronic control unit, the torque transmission path between the first transmission path and the second transmission path, when the speed ratio of the belt-type continuously variable transmission is equal to or larger than the predetermined threshold value.
